(19) United States
(12) Patent Application Publication
(10) Pub. No.: US 2023/0309602 A1
(43) Pub. Date: Oct. 5, 2023

(54) Intelligent Cut Tobacco Drying Control System and Method Based on Volatile Moisture Content

(71) Applicant: Zhangjiakou Cigarette Factory Co., Ltd., Zhangjiakou (CN)

(72) Inventors: Zijuan Li, Zhangjiakou (CN); Zixian Feng, Zhangjiakou (CN); Shuo Sun, Zhangjiakou (CN); Jiaojiao Chen, Zhangjiakou (CN); Yang Gao, Zhangjiakou (CN); Ting Fang, Zhangjiakou (CN); Wangchang Miao, Zhangjiakou (CN); Jichao Guo, Zhangjiakou (CN); Liyuan Zhao, Zhangjiakou (CN); Xiaohui Jia, Zhangjiakou (CN); Xiaohua Yang, Zhangjiakou (CN); Dongsheng Du, Zhangjiakou (CN); Yanshu Ma, Zhangjiakou (CN); Wenhui Chang, Zhangjiakou (CN); Jianbin Liang, Zhangjiakou (CN); Wei Wei, Zhangjiakou (CN); Cunrui Pang, Zhangjiakou (CN); Yanling Ma, Zhangjiakou (CN)

(21) Appl. No.: 18/129,071

(22) Filed: Mar. 31, 2023

(30) Foreign Application Priority Data
Mar. 31, 2022 (CN) 202210334728.2

(51) Int. Cl. A24B 3/04; A24B 9/00; G05D 7/06

(52) U.S. Cl. CPC A24B 3/04; A24B 9/00; G05D 7/0623

(57) ABSTRACT

Disclosed in the present disclosure is an intelligent cut tobacco drying control system and method based on volatile moisture content, wherein the system comprises a heat and mass transfer process analysis module, a material and energy accounting module, a prediction model module, a model control module and an abnormality early warning module. The present disclosure analyzes a drying process of the thin sheet shredded tobacco leaf drying machine, can provide theoretical support for building the intelligent control system under changeable conditions and realize intelligent production of drying shredded tobacco leaves. The present disclosure aims to transform the existing control mode and accurately predict the drainage opening by using a fitting model between the volatile moisture content and the drainage opening, so as to realize transformation from artificial control to intelligent control.

### CROSS REFERENCE TO RELATED APPLICATION

This application is based upon and claims priority to Chinese Patent Application No. 202210334728.2 filed on Mar. 31, 2022 and entitled “intelligent cut tobacco drying control system and method based on volatile moisture content”.

### FIELD OF TECHNOLOGY

The present invention is applied to the field of making shredded tobacco leaves, and in particular to an intelligent control system and an intelligent control method for drying shredded tobacco leaves based on volatile moisture content.

### BACKGROUND TECHNOLOGY

A thin sheet shredded tobacco leaf drying machine (thin-sheet shredded tobacco dryer) is an important equipment for shredded tobacco leaf production. The thin sheet shredded tobacco leaf drying machine uses steam to heat a cylinder wall and a shoveling plate, and at the same time, the cylinder wall, shoveling plate and hot air to heat shredded tobacco leaves, which can not only dry the excess moisture in the shredded tobacco leaves, but also improve a curling degree, a filling value and elasticity of the shredded tobacco leaves through rapid drying and shaping. The stability of temperature and moisture content at the outlet of shredded tobacco leaf drying directly affects the processing quality of finished shredded tobacco leaves and the intrinsic quality of cigarettes. Therefore, it is very critical to study a control system of thin sheet shredded tobacco leaf drying machine on the temperature and moisture control of the shredded tobacco leaves. At present, although big data and artificial intelligence play a predictive role, they are unable to analyze process changes and lack understanding of state changes of materials in a production process. Moreover, a construction cost is high, requiring a large amount of production data and hardware equipments.

At present, there are few studies on the heat and mass transfer process between shredded tobacco leaves and air flow during the operation of thin sheet shredded tobacco leaf drying machine. In order to fully grasp a drying mechanism, it is necessary to deeply study the material temperature change and water migration during the operation of thin sheet shredded tobacco leaf drying machine. At present, there is no study to analyze the production process of the thin sheet shredded tobacco leaf drying machine based on material accounting to build a heat and mass transfer model, and accurately calculate the heat and mass transfer during the shredded tobacco leaf drying process. There lacks enough theoretical supports for constructing an intelligent control system under changeable conditions. Therefore, an accurate control system and method are urgently needed to realize intelligent production.

### SUMMARY OF THE INVENTION

The present application provides an intelligent control system and an intelligent control method for drying shredded tobacco leaves based on volatile moisture content, aiming at transforming the existing control mode, using a fitting model of the volatile moisture content and drainage opening to accurately predict the drainage opening, and realizing a transformation from a manual control to an intelligent control.

The technical solution adopted by the present invention to solve its technical problem is as follows:

An intelligent cut tobacco drying control method based on volatile moisture content, wherein the method comprises the following steps:
(1) performing a heat and mass transfer process analysis based on the conservation of dry matter mass and moisture mass of the shredded tobacco leaves, analyzing a thin sheet shredded tobacco leaf drying process of a shredded tobacco leaf drying machine to obtain parameters for constructing a material and energy accounting model in the thin sheet shredded tobacco leaf drying process;
(2) performing material and energy balance accounting
performing the material and energy balance accounting regarding to shredded tobacco leaf dry matter mass in the HT stage, moisture mass in the HT stage, shredded tobacco leaf dry matter mass in the thin sheet stage and moisture mass in the thin sheet stage respectively, and calculating the heat and mass transfer during the shredded tobacco leaf drying process;
2A) mass conservation of shredded tobacco leaf dry matter in the HT stage a calculation formula is as follows: Ws,in×(1−Hs,in)=Ws,mid×(1−Hs,mid)+W1,loss where, Ws,in, Ws,mid are the material mass flow at an HT inlet and the HT outlet respectively;
Hs,in, Hs,mid are the moisture content of the shredded tobacco leaves at the HT inlet and the HT outlet respectively;
W1,loss is dry matter loss in the HT stage;
2B) mass conservation of moisture in the HT stage
a calculation formula is as follows:

AH(Tg,inHT)×Vg,inHT=(Ws,mid×Hs,mid−Ws,in×Hs,in)+AH(Tg,outHT)×Vg,outHT×RH_{HT}+H1,loss
where AH(Tg) is absolute humidity under a gas saturated steam pressure; Vg,inHT, Vg,outHT are the steam volume flow of the HT inlet and the HT outlet respectively;
RH_{HT} is relative humidity at the HT outlet;
H1,loss is moisture loss in the HT stage;

Ws,mid=Ws,in+AH(Tg,inHT)×Vg,inHT−AH(Tg,outHT)×Vg,outHT×RH_{HT}.
according to the above calculation formulas, deriving moisture content Hs,mid of shredded tobacco leaves at the HT outlet as follows:

$$H s , m i d = \frac{\begin{matrix}AH ( Tg , inHT ) \times V g , i n H T - A H ( Tg , outHT ) \times \\ Vg , outHT \times R {H}_{H T} + Ws , in \times Hs , in\end{matrix}}{\begin{matrix}Ws , in + A H ( T g , i n H T ) \times \\ Vg , inHT - AH ( Tg , outHT ) \times Vg , outHT \times R {H}_{H T}\end{matrix}} ;$$

deriving mass flow of moisture entering the shredded tobacco leaves in the HT stage as follows:

$$\frac{d {X}_{W , HT}}{d t} = ( W s , m i d - Ws , in ) = {K}_{m , H T} \times [ Ws , in \times ( 1 - Hs , in ) ] \times \frac{A H ( Tg , inHT ) \times V g , i n H T}{V g , i n D H T} ;$$

where K_{m,HT} is a conversion coefficient under which an HT lower cover plate pressure is converted into moisture in the shredded tobacco leaves;
2C) mass conservation of shredded tobacco leaves dry matter in the thin sheet stage
a calculation formula is as follows:

Ws,mid×(1−Hs,mid)=Ws,out×(1−Hs,out)+W2,loss;
where Ws,out is the flow of shredded tobacco leaves at the outlet of the thin sheet;

$$Ws , out = \frac{W s , m i d \times ( 1 - Hs , mid )}{( 1 - Hs , out )} ;$$

Hs,out is the moisture content of the shredded tobacco leaves at the outlet of the thin sheet;
W2,loss is the dry matter loss in the thin sheet stage;
2D) mass conservation of moisture in the thin sheet stage
a calculation formula is as follows:

Ws,mid×Hs,mid=(Ws,mid−Ws,out)+Ws,out×Hs,out+H2,loss;
where H2,loss is moisture loss in the thin sheet stage;
mass flow of moisture evaporated from the shredded tobacco leaves in the thin sheet stage is as follows:

$$\frac{d {X}_{W , dry}}{d t} = ( W s , m i d - Ws , out ) = {k}_{m , dry} \times Ws , m i d \times ( 1 - Hs , mid ) \times [ ρ v , sat ( Ts , out ) \times exp ( - \frac{Δ {E}_{v}}{R {T}_{TS , out}} ) - ρ v , b ] ;$$

where, k_{m,dry} is the drying coefficient;
ρv,sat is saturated steam concentration;
ρv,b is the hot air steam concentration;
a total drying coefficient is as follows:

$${K}_{M , dry} ( Ts , out ) = {k}_{m , dry} \times exp ( - \frac{Δ Ev}{{RT}_{TS , out}} ) ;$$

thus obtaining a simplified formula of mass flow of moisture evaporated from the shredded tobacco leaves in the thin sheet stage as follows:

$$\frac{d {X}_{W , dry}}{d t} = ( W s , m i d - Ws , out ) = {K}_{M , dry} ( Ts , out ) \times Ws , mid \times ( 1 - Hs , mid ) \times ρ v , sat ( Ts , out ) ;$$

(3) constructing prediction models
3A) constructing and obtaining a relationship between a steam pressure and a mass transfer coefficient of steam to the shredded tobacco leaves of a lower cover plate
analyzing a correlation between the steam pressure and the mass transfer coefficient of steam to the shredded tobacco leaves under different HTs and fitting a correlation function as follows:

K_{m,HT}=0.05735−0.11×(Pg,inDHT+0.1).
adopting the mass transfer coefficient of steam to the shredded tobacco leaves K_{m,HT} to obtain a prediction model of moisture content at the HT outlet as follows:

$$H s , mid = \frac{\begin{matrix}{K}_{m , HT} \times [ Ws , in \times ( 1 - Hs , in ) ] \times \\ \frac{A H ( Tg , inHT ) \times V g , i n H T}{V g , i n D H T} + Ws , in \times Hs , in\end{matrix}}{Ws , mid} ;$$

3B) constructing and obtaining a relationship between a drying coefficient of the thin sheet and an outlet temperature of the shredded tobacco leaves on the thin sheet
fitting a correlation function as follows:

$${K}_{M , dry} ( Ts , out ) = {k}_{m , dry} \times exp ( - \frac{Δ E v}{R {T}_{T S , o u t}} ) = 6.38568 - 0.0857 \; 11 \times ( Ts , out - 273.15 ) ;$$

obtaining the prediction model of moisture content at the outlet of the thin sheet as follows:

$$Hs , out = \frac{\begin{matrix}Ws , m i d \times H s , m i d - {K}_{M , dry} ( Ts , out ) \times \\ Ws , mid \times ( 1 - H s , m i d ) \times ρ v , sat ( Ts , out )\end{matrix}}{Ws , out} ;$$

3C) constructing and obtaining a relationship between the moisture drainage opening of the thin sheet and a mass flow of volatile moisture in the shredded tobacco leaves
fitting a correlation function as follows:

$$\frac{d {W}_{W , dry}}{d t} = W s , m i d - Ws , out = 663.49 - 29350.8 \times {( 0.8706 )}^{OP , dry} ;$$

obtaining a prediction model of the moisture drainage opening OP, dry according to the dry volatile moisture content as follows:

$$OP , dry = {log}_{0.8706} \frac{Ws , out - Ws , mid + 663.49}{29350.8} ;$$

(4) controlling the prediction models
embedding the prediction models into a control system of the shredded tobacco leaf drying machine to realize automatic data collection, calculation and control;
(5) executing abnormality early warning
when a deviation between a predicted value and a measured value of the moisture content at the outlet of the thin sheet is greater than or equal to 0.5%, giving an alarm by the control system, and entering an abnormality treating process.

Also, the present disclosure provides an intelligent cut tobacco drying control method based on volatile moisture content, the system is used to implement the intelligent cut tobacco drying control method according to any one of the above solutions, wherein the system comprises:
a heat and mass transfer process analysis module,
configured to analyze a thin sheet shredded tobacco leaf drying process of a shredded tobacco leaf drying machine based on the conservation of dry matter mass and moisture mass of shredded tobacco leaves, so as to obtain parameters for constructing a material and energy accounting model in the thin sheet shredded tobacco leaf drying process;
a material and energy accounting module,
configured to perform material and energy balance accounting regarding to shredded tobacco leaves dry matter mass in the HT stage, moisture mass in the HT stage, shredded tobacco leaves dry matter mass in the thin sheet stage and moisture mass in the thin sheet stage respectively, and calculates the heat and mass transfer during the shredded tobacco leaf drying process;
a prediction model module,
configured to construct and obtain prediction models,
wherein based on a relationship between a steam pressure and a mass transfer coefficient of steam to the shredded tobacco leaves of a lower cover plate, a relationship between a drying coefficient of the thin sheet and an outlet temperature of the shredded tobacco leaves on the thin sheet, and a relationship between the drainage opening of the thin sheet and a mass flow of volatile moisture in the shredded tobacco leaves, the prediction model module obtains a prediction model of moisture content at the HT outlet, a prediction model of moisture content at the outlet of thin sheet, and a prediction model of the moisture drainage opening OP,dry by fitting a correlation function;
a model control module,
configured to realize automatic data collection, calculation and control by embedding the prediction models into a control system of the shredded tobacco leaf drying machine;
and, an abnormality early warning module,
configured to give an alarm wherein when a deviation between a predicted value and a measured value of the moisture content at the outlet of the thin sheet is greater than or equal to 0.5%, and enter into an abnormality treating process.

The beneficial effects brought by the present invention are as follows:

Based on material and energy accounting, the present application analyzes a production process of thin sheet shredded tobacco leaf drying machine, builds a heat and mass transfer calculation model, and accurately calculates heat and mass transfer in a shredded tobacco leaf drying process, which can provide theoretical support for building the intelligent control system under changeable conditions and realize intelligent production of drying shredded tobacco leaves. The purpose of the present invention is to transform the existing control mode and accurately predict the drainage opening by using a fitting model between the volatile moisture content and the drainage opening, so as to realize transformation from artificial control to intelligent control.

### BRIEF DESCRIPTION OF THE DRAWINGS

The present disclosure will be further described below in conjunction with the accompanying drawings and specific embodiments,

FIG. 1 is a schematic diagram of main parameters of a material and energy accounting model in a thin sheet shredded tobacco leaf drying process;

FIG. 2 and FIG. 3 are schematic diagrams of a relationship between a steam pressure and a mass transfer coefficient of steam to the shredded tobacco leaves of a lower cover plate;

FIG. 4 is a schematic diagram of a relationship between a drying coefficient of a thin sheet and an outlet temperature of shredded tobacco leaves on the thin sheet;

FIG. 5 and FIG. 6 are schematic diagrams of a relationship between the moisture drainage opening of a thin sheet and a mass flow of volatile moisture in shredded tobacco leaves; and

FIG. 7 is a schematic diagram of an abnormality early warning process.

### DESCRIPTION OF THE EMBODIMENTS

Technical schemes in embodiments of the present invention are clearly and completely described in the following in combination with the drawings accompanying the embodiments of the present invention. Obviously, the described embodiments are only a part of the embodiments of the present invention, but not the total embodiments. Based on the embodiments of the present invention, all the other embodiments obtained by those of ordinary skill in the art without inventive effort are within the scope of the present invention.

In this embodiment, provided is an intelligent control method for drying shredded tobacco leaves based on volatile moisture content, wherein the method comprises the following steps:
(1) performing a heat and mass transfer process analysis

Based on the conservation of dry matter mass and moisture mass of the shredded tobacco leaves to analyze a HT stage and a thin sheet stage of a thin sheet shredded tobacco leaf drying process for a thin sheet shredded tobacco leaf drying machine so as to obtain main parameters for constructing a material and energy accounting model in the thin sheet shredded tobacco leaf drying process (as shown in FIG. 1).

Analyzing an HT Stage:

The HT stage (tunnel type moisture regaining) of a shredded tobacco leaf drying machine is mainly used to heat and humidify the shredded tobacco leaves by saturated steam. The steam contacts the shredded tobacco leaves, and the moisture in the steam enters the shredded tobacco leaves through diffusion, completing a gas-solid two-phase mass transfer process. The heat of the steam and heat generated in a moisture liquefaction process enter the shredded tobacco leaves, and the heating process of the shredded tobacco leaves is completed. Analyzing the heat transfer process and mass transfer process of the system:

Basic Assumption:
A. The shredded tobacco leaves are taken as a system to study;
B. In the HT stage, the steam is sprayed by the upper and lower cover plates, the flow of the upper cover plate and the flow of the lower cover plate are quite different, and its value can be ignored, and in the calculation, the steam concentration is calculated by the lower cover plate;
C. Heat input in the HT stage is from the steam, and it is assumed that heat exchange and change only occur in the gas-solid two-phase (steam-shredded tobacco leaves);
D. The moisture mass transfer process is based on a single layer membrane theory of gas-solid mass transfer, and experimental data is tested and the mass transfer coefficient is calculated;
E. It is assumed that the steam is saturated during the HT process.

Analyzing a Thin Sheet Stage:

The thin sheet stage (thin sheet shredded tobacco leaf drying) of a thin sheet shredded tobacco leaf drying machine mainly transfers heat energy into the shredded tobacco leaves through the steam, and the moisture in the shredded tobacco leaves absorbs heat and volatilizes, thus completing the drying stage of the shredded tobacco leaves. The steam indirectly transfers heat into the shredded tobacco leaves by heating the hot air and the thin sheet, so as to complete the process of moisture heating and volatilization, wherein the cooling of the shredded tobacco leaves themselves provides part of the energy for the moisture volatilization. In the process of the thin sheet shredded tobacco leaf drying, moisture volatilization is realized through the heat transfer to complete the process of drying and dehydration of the shredded tobacco leaves. In the whole process of the heat transfer, the steam does not directly contact the shredded tobacco leaves, and the gas temperature at the drainage outlet thereof is high, so energy consumption and energy loss are high in the process.

Basic Assumption:
A. The state at the HT outlet is consistent with the shredded tobacco leaf material and thermodynamic states at the inlet of the thin sheet shredded tobacco leaf drying machine;
B. The steam does not directly contact the shredded tobacco leaves, heat conduction is carried out through the hot air and thin sheet and the heat transfers into the shredded tobacco leaves, and the drying stage is completed, wherein the equipment state is constant under stable production, and there is no other heat exchange process;
C. The drying process of shredded tobacco leaves is simplified based on a reaction engineering model and a total drying coefficient is calculated.

Refer to FIG. 1, which shows main parameters for constructing a material and energy accounting model in the thin sheet shredded tobacco leaf drying process.
(2) performing material and energy accounting
2A) performing the accounting of mass conservation of shredded tobacco leaf dry matter in the HT stage:
a calculation formula is as follows: Ws,in×(1−Hs,in)=Ws,mid×(1−Hs,mid)+W1,loss
where Ws,mid is the mass flow of shredded tobacco leaves at the HT outlet, kg/h;

$$W s , m i d = \frac{Ws , in \times ( 1 - Hs , in )}{( 1 - H s , m i d )}$$

Hs,mid is the moisture content of the shredded tobacco leaves at the HT outlet, %;
it is necessary to calculate the following in the formula;
Ws,inHT is the flow of shredded tobacco leaves at the HT inlet, kg/h;
Hs,in is the moisture content of the shredded tobacco leaves at the HTinlet, %;
W1,loss is dry matter loss in the HT stage, kg/h.
2B) performing the accounting of mass conservation of moisture in the HT stage: a calculation formula is as follows:

AH(Tg,inHT)×Vg,inHT=(Ws,mid×Hs,mid−Ws,in×Hs,in)+AH(Tg,outHT)×Vg,outHT×RH_{HT}+H1,loss
where AH(Tg) is absolute humidity under a gas saturated steam pressure (applicable to 0˜200° C. gas), kg/m³;

$$A H ( T g ) = 2170 \times \frac{{e}^{( \frac{- 5800.2206}{T} + 1.3915 - 0.04864 \times T + 4.1765 \times {10}^{- 5} \times {T}^{2} - 1.4452 \times 1 {0}^{- 8} \times {T}^{3} + 6.54 \; 597 \times InT )}}{T} ;$$

$$T = 27 \; 3.15 + t ;$$

T is a thermodynamic temperature, K; t is a centigrade temperature, ° C.;
AH(Tg, inHT) is the absolute humidity under a gas saturated steam pressure at the HT inlet, kg/m³;
AH(Tg, outHT) is the absolute humidity under a gas saturated steam pressure at the HT outlet, kg/m³;
Vg,inHT is the volume flow at the HT inlet, m³/h;
Vg,outHT is the volume flow at the HT outlet, m³/h;
Ws,mid is the mass flow at the HT outlet, kg/h;

Ws,mid=Ws,in+AH(Tg,inHT)×Vg,inHT−AH(Tg,outHT)×Vg,outHT×RH_{HT};
H1,loss is moisture loss, kg/h; this part is ignored because of material loss and mass flow, kg/h, W1,loss+H1,loss=1.69 in the HT stage.
according to the conservation formulas, deriving moisture content Hs,mid of shredded tobacco leaves at the HT outlet, % as follows:

$$H s , m i d = \frac{\begin{matrix}AH ( Tg , inHT ) \times V g , i n H T - A H ( Tg , outHT ) \times \\ Vg , outHT \times R {H}_{H T} + Ws , in \times Hs , in\end{matrix}}{\begin{matrix}Ws , in + A H ( T g , i n H T ) \times \\ Vg , inHT - AH ( Tg , outHT ) \times Vg , outHT \times R {H}_{H T}\end{matrix}} ;$$

deriving mass flow of moisture entering the shredded tobacco leaves in the HT stage, kg/h as follows:

$$\frac{d {X}_{W , HT}}{d t} = ( W s , m i d - Ws , in ) = {K}_{m , H T} \times [ Ws , in \times ( 1 - Hs , in ) ] \times \frac{A H ( Tg , inHT ) \times V g , i n H T}{V g , i n D H T} ;$$

in the formula, K_{m,HT} is a conversion coefficient under which an HT lower cover plate pressure is converted into moisture in the shredded tobacco leaves.
2C) performing the accounting of mass conservation of shredded tobacco leaves dry matter in the thin sheet stage:
a calculation formula is as follows:

Ws,mid×(1−Hs,mid)=Ws,out×(1−Hs,out)+W2,loss;
where Ws,out is the flow of shredded tobacco leaves at the HT outlet, kg/h;

$$Ws , out = \frac{W s , m i d \times ( 1 - Hs , mid )}{( 1 - Hs , out )} ;$$

Hs,out is the moisture content of the shredded tobacco leaves at the outlet of the thin sheet, %; it is necessary to calculate the following in the formula;
W2,loss is dry matter loss, kg/h.
2D) performing the accounting of mass conservation of moisture in the thin sheet stage:
a calculation formula is as follows:

Ws,mid×Hs,mid=(Ws,mid−Ws,out)+Ws,out×Hs,out+H2,loss.
where H2,loss is moisture loss, kg/h.
mass flow of moisture evaporated from the shredded tobacco leaves in the thin sheet stage is, kg/h as follows:

$$\frac{d {X}_{W , dry}}{d t} = ( W s , m i d - Ws , out ) = {k}_{M , dry} \times Ws , mid \times ( 1 - Hs , mid ) \times [ ρ v , sat ( Ts , out ) \times exp ( - \frac{Δ {E}_{v}}{{RT}_{TS , out}} ) - ρ v , b ] ;$$

where, k_{m,dry} is the drying coefficient;
ρv, sat is saturated steam concentration, kg/m³

$$ρ v , sat = 1 {0}^{- 3} ( \frac{exp ( 31.3716 - \frac{6014.79}{Ts , out} - 7.92495 \times 1 {0}^{- 3} \times Ts , out )}{Ts , out} ) ;$$

ρv, b is the hot air steam concentration, kg/m³; ρv, b=RH×ρv, sat;
Because the actual measured relative humidity RH of the hot air is less than 0.8%, this part is ignored.

A total drying coefficient is as follows:

$${K}_{M , dry} ( Ts , out ) = {k}_{m , dry} \times exp ( - \frac{Δ E v}{R {T}_{T S , o u t}} ) ;$$

thus obtaining a simplified formula of mass flow of moisture evaporated from the shredded tobacco leaves in the thin sheet stage as follows:

$$\frac{{dX}_{W , dry}}{dt} = ( Ws , mid - Ws , out ) = {K}_{M , dry} ( Ts , out ) \times Ws , \text{} mid \times ( 1 - Hs , mid ) \times ρ v , sat ( Ts , out ) ;$$

(3) constructing prediction models
3A) studying on a relationship between a steam pressure and a steam mass transfer coefficient of a lower cover plate

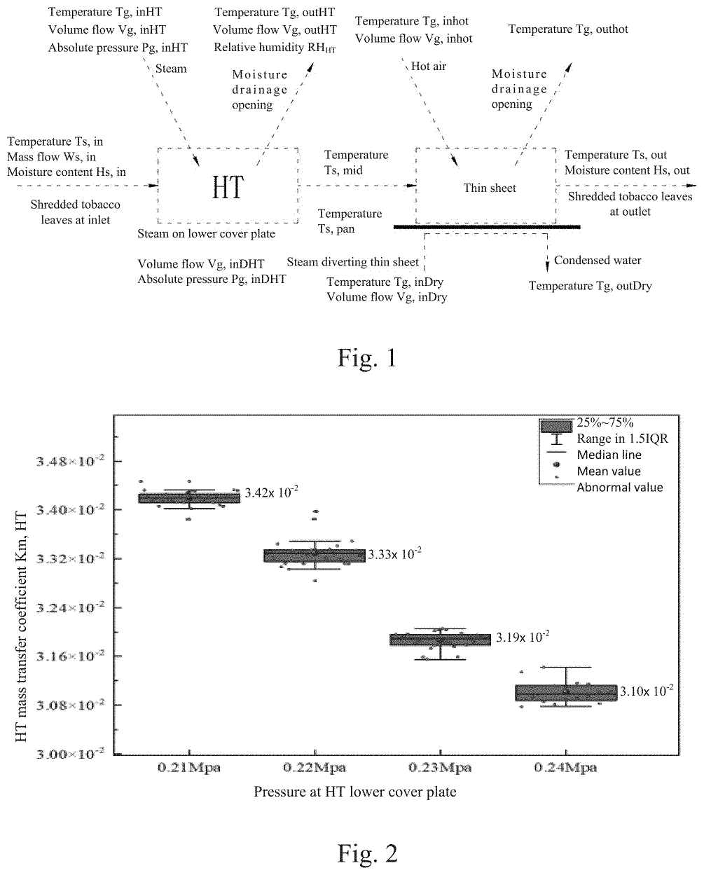

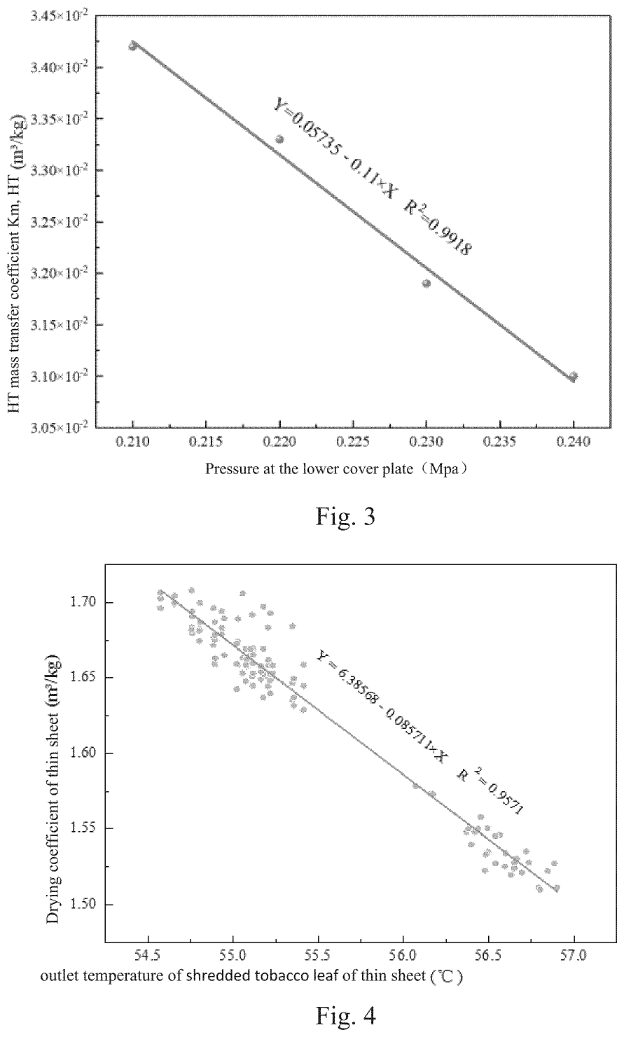

Refer to FIG. 2 and FIG. 3, which show a relationship between a steam pressure and a steam mass transfer coefficient of a lower cover plate;
according to the above material accounting formula, analyzing a correlation between the pressure and the mass transfer coefficient from steam to the shredded tobacco leaves under different HTs and fitting a correlation function as follows:

K_{m,HT}=0.05735−0.11×(Pg,inDHT+0.1).
using the mass transfer coefficient from the steam to the shredded tobacco leaves K_{m,HT} to obtain a prediction model of moisture content at the HT outlet as follows:

$$Hs , mid = \frac{\begin{matrix}{K}_{m , HT} \times [ Ws , in \times ( 1 - Hs , in ) ] \times \\ \frac{AH ( Tg , inHT ) \times Vg , inHT}{Vg , inDHT} + Ws , in \times Hs , in\end{matrix}}{Ws , mid}$$

3B) studying on a relationship between a drying coefficient of the thin sheet and an outlet temperature of the shredded tobacco leaves on the thin sheet

Refer to FIG. 4, which shows a relationship between a drying coefficient of the thin sheet and an outlet temperature of the shredded tobacco leaves on the thin sheet;
fitting a correlation function as follows:

$${K}_{M , dry} ( Ts , out ) = {k}_{m , dry} \times exp ( - \frac{Δ Ev}{{RT}_{TS , out}} ) = 6.38568 - 0.085711 \times ( Ts , out - 273.15 ) ;$$

obtaining the prediction model of moisture content at the outlet of the thin sheet as follows:

$$Hs , out = \frac{\begin{matrix}Ws , mid \times Hs , mid - {K}_{M , dry} ( Ts , out ) \times Ws , mid \times \\ ( 1 - Hs , mid ) \times ρ v , sat ( Ts , out )\end{matrix}}{Ws , out} ;$$

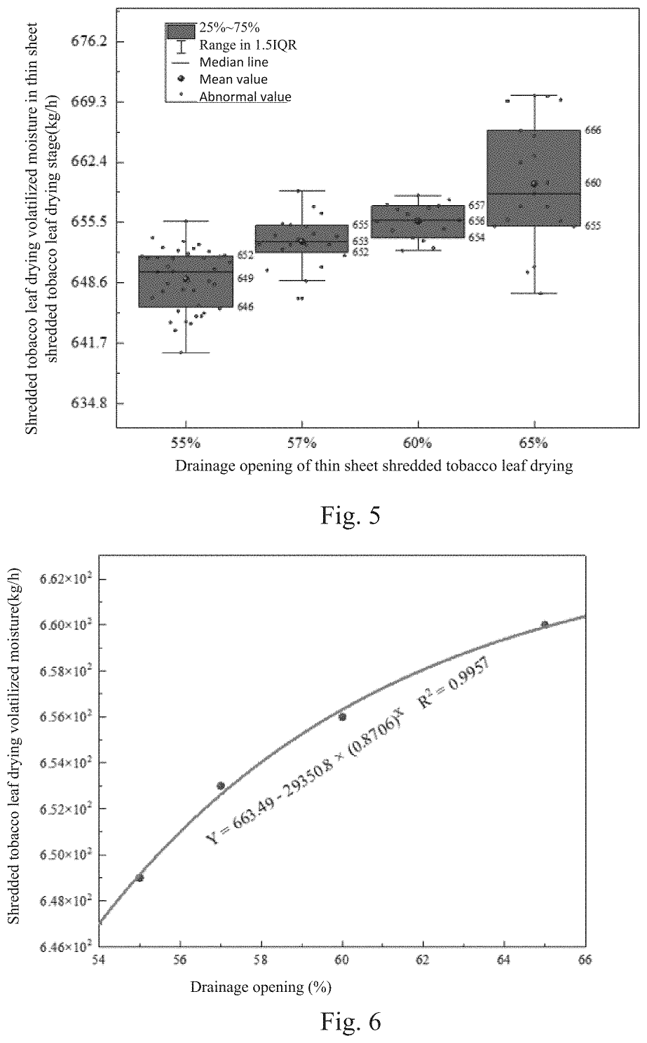

3C) studying on a relationship between the drainage opening of the thin sheet and a mass flow of volatile moisture in the shredded tobacco leaves
Refer to FIG. 5 and FIG. 6, which show a relationship between the drainage opening of a thin sheet and a mass flow of volatile moisture in shredded tobacco leaves; and
fitting a correlation function as follows:

$$\frac{{dW}_{W , dry}}{dt} = Ws , mid - Ws , out = 663.49 - 29350.8 \times {( 0.8706 )}^{OP , dry} ;$$

obtaining a prediction model of the drainage opening OP,dry according to the dry volatile moisture content as follows:

$$OP , dry = {log}_{0.8706} \frac{Ws , out - Ws , mid + 663.49}{29350.8} ;$$

(4) controlling the prediction models
by means of information technology, embedding the prediction models into a control system of a shredded tobacco leaf drying machine to realize automatic data collection, calculation and control, so as to instead manual control.
(5) executing abnormality early warning

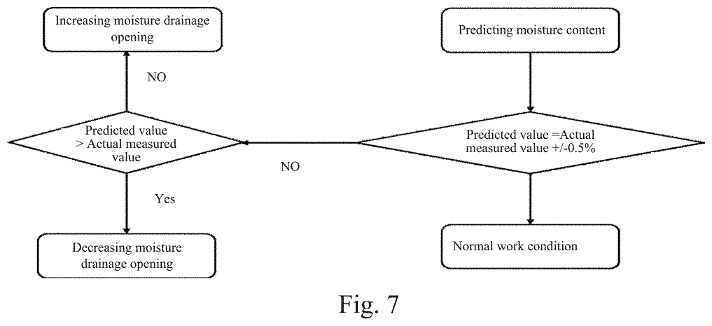

Refer to FIG. 7, when a deviation between a predicted value and a measured value of the moisture content at the outlet of the thin sheet is greater than or equal to 0.5%, the system gives an alarm; and an abnormality processing is entered.

Also, in this embodiment, provided is an intelligent control system for drying shredded tobacco leaves based on volatile moisture content, the system is used to implement the intelligent control method of drying shredded tobacco leaves based on volatile moisture content described as above, wherein the system comprises:
a heat and mass transfer process analysis module,
wherein based on the conservation of dry matter mass and moisture mass of shredded tobacco leaves, the heat and mass transfer process analysis module analyzes a production process of thin sheet shredded tobacco leaf drying process so as to obtain main parameters for constructing a material and energy accounting model in the thin sheet shredded tobacco leaf drying process;
a material and energy accounting module,
wherein the material and energy accounting module accounts the material and energy for shredded tobacco leaves dry matter mass in an HT stage, moisture mass in an HT stage, shredded tobacco leaves dry matter mass in a thin sheet stage and moisture mass in the thin sheet stage respectively, and calculates the heat and mass transfer during the shredded tobacco leaf drying process;
a prediction model module,
wherein based on a relationship between a steam pressure and a steam mass transfer coefficient of a lower cover plate, a relationship between a drying coefficient of the thin sheet and an outlet temperature of the shredded tobacco leaves on the thin sheet, and a relationship between the drainage opening of the thin sheet and a mass flow of volatile moisture in the shredded tobacco leaves, the prediction model module obtains a prediction model of moisture content at the HT outlet, a prediction model of moisture content at the outlet of thin sheet, and a prediction model of the drainage opening OP, dry by fitting a correlation function;
a model control module,
wherein by means of information technology, the model control module embeds the established prediction models into a control system of a shredded tobacco leaf drying machine to realize automatic data collection, calculation and control;
and, an abnormality early warning module,
wherein when a deviation between a predicted value and a measured value of the moisture content at the outlet of the thin sheet is greater than or equal to 0.5%, the system gives an alarm; and an abnormality processing is entered.

An Application Example:

The intelligent control system and intelligent control method for drying shredded tobacco leaves based on volatile moisture content described in the above embodiments are put into the workshop for real-time prediction of the drainage opening of the shredded tobacco leaf drying machine. The results are shown in Table 1:

TABLE 1
Comparative statistical table of predicted and actual values of drainage
opening

| | Actual | Predicted |
|---|---|---|
| | drainage | drainage |
| | opening | opening |
| 1 | 55 | 57 |
| 2 | 55 | 56 |
| 3 | 56 | 56 |
| 4 | 55 | 56 |
| 5 | 54 | 56 |
| 6 | 55 | 55 |
| 7 | 55 | 56 |
| 8 | 56 | 57 |
| 9 | 55 | 56 |
| 10 | 55 | 56 |
| 11 | 55 | 56 |
| 12 | 56 | 57 |
| 13 | 57 | 56 |
| 14 | 57 | 57 |
| 15 | 57 | 57 |
| 16 | 57 | 59 |
| 17 | 57 | 57 |
| 18 | 55 | 56 |
| 19 | 57 | 58 |
| 20 | 57 | 57 |
| 21 | 57 | 56 |
| 22 | 57 | 57 |
| 23 | 59 | 58 |
| 24 | 58 | 57 |
| 25 | 59 | 58 |
| 26 | 57 | 57 |
| 27 | 55 | 56 |
| 28 | 59 | 58 |
| 29 | 56 | 57 |
| 30 | 57 | 58 |

It should be noted that the above are only preferred embodiments of the present invention, and are not intended to limit the present invention. Although the present invention has been described in detail with reference to the foregoing embodiments, for those skilled in the art, it is still possible to modify the technical solutions recorded in the foregoing embodiments, or equivalently replace some technical features thereof. Any modifications, equivalent replacements, improvements, etc. made within the spirit and principle of the present invention shall be included in the protection scope of the present invention.

What is claimed is:

1. An intelligent cut tobacco drying control method based on volatile moisture content, wherein the method comprises the following steps:
(1) performing a heat and mass transfer process analysis
based on the conservation of dry matter mass and moisture mass of the shredded tobacco leaves, analyzing a thin sheet shredded tobacco leaf drying process of a thin sheet shredded tobacco leaf drying machine so as to obtain parameters for constructing a material and energy accounting model in the thin sheet shredded tobacco leaf drying process;
(2) performing the material and energy accounting
performing the material and energy accounting regarding to shredded tobacco leaf dry matter mass in the HT stage, moisture mass in the HT stage, shredded tobacco leaf dry matter mass in the thin sheet stage and moisture mass in the thin sheet stage respectively, and calculating the heat and mass transfer during the shredded tobacco leaf drying process accurately;
(3) constructing prediction models
based on a relationship between a steam pressure and a mass transfer coefficient of steam to the shredded tobacco leaves of a lower cover plate, obtaining a prediction model of moisture content at an HT outlet by fitting a correlation function;
based on a relationship between a drying coefficient of the thin sheet and an outlet temperature of the shredded tobacco leaves on the thin sheet, obtaining a prediction model of moisture content at the outlet of thin sheet by fitting a correlation function;
based on a relationship between the moisture drainage opening of the thin sheet and a mass flow of volatile moisture in the shredded tobacco leaves, obtaining a prediction model of the moisture drainage opening OP,dry by fitting a correlation function and according to the dry volatile moisture content;
(4) controlling the prediction models
embedding the prediction models into a control system of the shredded tobacco leaf drying machine to realize automatic data collection, calculation and control;
(5) executing abnormality early warning
when a deviation between a predicted value and a measured value of the moisture content at the outlet of the thin sheet is greater than or equal to 0.5%, giving an alarm by the control system; entering an abnormality treating process.

2. The intelligent cut tobacco drying control method based on volatile moisture content according to claim 1, wherein
step (2) comprises:
2A) mass conservation of shredded tobacco leaf dry matter in the HT stage a calculation formula is as follows: Ws,in×(1−Hs,in)=Ws,mid×(1−Hs,mid)+W1,loss
where, Ws,in, Ws,mid are the material mass flow at an HT inlet and the HT outlet respectively;
Hs,in, Hs,mid are the moisture content of the shredded tobacco leaves at the HT inlet and the HT outlet respectively;
W1,loss is dry matter loss in the HT stage;
2B) mass conservation of moisture in the HT stage
a calculation formula is as follows:
AH(Tg,inHT)×Vg,inHT=(Ws,mid×Hs,mid−Ws,in×Hs,in)+AH(Tg,outHT)×Vg,outHT×RH_{H}T+H1,loss
where AH(Tg) is absolute humidity under a gas saturated steam pressure;
Vg,inHT, Vg,outHT are the steam volume flow of the HT inlet and the HT outlet respectively;
RH_{HT} is relative humidity at the HT outlet;
H1,loss is moisture loss in the HT stage;
Ws,mid=Ws,in+AH(Tg,inHT)×Vg,inHT−AH(Tg,outHT)×Vg,outHT×RH_{HT};
according to the above calculation formulas, deriving moisture content Hs,mid of shredded tobacco leaves at the HT outlet as follows:
$$Hs , mid = \frac{\begin{matrix}AH ( Tg , inHT ) \times Vg , inHT - AH ( Tg , outHT ) \times \\ Vg , outHT \times {RH}_{HT} + Ws , in \times Hs , in\end{matrix}}{\begin{matrix}Ws , in + AH ( Tg , inHT ) \times Vg , inHT - AH ( Tg , outHT ) \times \\ Vg , outHT \times {RH}_{HT}\end{matrix}} ;$$
deriving mass flow of moisture entering the shredded tobacco leaves in the HT stage as follows:
$$\frac{{dX}_{W , HT}}{dt} = ( Ws , mid - Ws , in ) = {K}_{m , HT} \times [ Ws , in \times ( 1 - Hs , in ) ] \times \frac{AH ( Tg , inHT ) \times Vg , inHT}{Vg , inDHT} ;$$
where K_{m,HT} is a conversion coefficient under which an HT lower cover plate pressure is converted into moisture in the shredded tobacco leaves;
2C) mass conservation of shredded tobacco leaves dry matter in the thin sheet stage a calculation formula is as follows:
Ws,mid×(1−Hs,mid)=Ws,out×(1−Hs,out)+W2,loss.
where Ws,out is the flow of shredded tobacco leaves at the outlet of the thin sheet;
$$Ws , out = \frac{Ws , mid \times ( 1 - Hs , mid )}{( 1 - Hs , out )} ;$$
Hs,out is the moisture content of the shredded tobacco leaves at the outlet of the thin sheet;
W2,loss is the dry matter loss in the thin sheet stage;
2D) mass conservation of moisture in the thin sheet stage
a calculation formula is as follows:
Ws,mid×Hs,mid=(Ws,mid−Ws,out)+Ws,out×Hs,out+H2,loss;
where H2,loss is moisture loss in the thin sheet stage;
mass flow of moisture evaporated from the shredded tobacco leaves in the thin sheet stage is as follows:
$$\frac{{dX}_{W , dry}}{dt} = ( Ws , mid - Ws , out ) = {k}_{m , dry} \times Ws , mid \times ( 1 - Hs , mid ) \times [ ρ v , sat ( Ts , out ) \times exp ( - \frac{Δ {E}_{v}}{{RT}_{TS , out}} ) - ρ v , b ] ;$$
where, k_{m,dry} is the drying coefficient;
ρv, sat is saturated steam concentration;
ρv,b is the hot air steam concentration;
a total drying coefficient is as follows:
$${K}_{M , dry} ( Ts , out ) = {k}_{m , dry} \times exp ( - \frac{Δ Ev}{{RT}_{TS , out}} ) ;$$
thus obtaining a simplified formula of mass flow of moisture evaporated from the shredded tobacco leaves in the thin sheet stage as follows:
$$\frac{{dX}_{W , dry}}{dt} = ( Ws , mid - Ws , out ) = {K}_{M , dry} ( Ts , out ) \times Ws , \text{} mid \times ( 1 - Hs , mid ) \times ρ v , sat ( Ts , out ) .$$

3. The intelligent cut tobacco drying control method based on volatile moisture content according to claim 1, wherein
the prediction model of moisture content at the HT outlet is as follows:
$$Hs , mid = \frac{\begin{matrix}{K}_{m , HT} \times [ Ws , in \times ( 1 - Hs , in ) ] \times \\ \frac{AH ( Tg , inHT ) \times Vg , inHT}{Vg , inDHT} + Ws , in \times Hs , in\end{matrix}}{Ws , mid} .$$

4. The intelligent cut tobacco drying control method based on volatile moisture content according to claim 1, wherein
the prediction model of moisture content at the outlet of thin sheet is as follows:
$$Hs , out = \frac{\begin{matrix}Ws , mid \times Hs , mid - {K}_{M , dry} ( Ts , out ) \times Ws , mid \times \\ ( 1 - Hs , mid ) \times ρ v , sat ( Ts , out )\end{matrix}}{Ws , out} .$$

5. The intelligent cut tobacco drying control method based on volatile moisture content according to claim 1, wherein
the prediction model of the moisture drainage opening OP, dry is as follows:
$$OP , dry = {log}_{0.8706} \frac{Ws , out - Ws , mid + 663.49}{29350.8} .$$

6. An intelligent cut tobacco drying control system based on volatile moisture content, the system is used to implement the intelligent cut tobacco drying control method according to claim 1, wherein the system comprises:
a heat and mass transfer process analysis module,
configured to analyze a thin sheet shredded tobacco leaf drying process of a thin sheet shredded tobacco leaf drying machine based on the conservation of dry matter mass and moisture mass of shredded tobacco leaves, so as to obtain parameters for constructing a material and energy accounting model in the thin sheet shredded tobacco leaf drying process;
a material and energy accounting module,
configured to perform material and energy balance accounting regarding to shredded tobacco leaves dry matter mass in the HT stage, moisture mass in the HT stage, shredded tobacco leaves dry matter mass in the thin sheet stage and moisture mass in the thin sheet stage respectively, and calculate the heat and mass transfer during the shredded tobacco leaf drying process;
a prediction model module,
configured to construct and obtain prediction models, wherein based on a relationship between a steam pressure and a mass transfer coefficient of steam to the shredded tobacco leaves of a lower cover plate, a relationship between a drying coefficient of the thin sheet and an outlet temperature of the shredded tobacco leaves on the thin sheet, and a relationship between the drainage opening of the thin sheet and a mass flow of volatile moisture in the shredded tobacco leaves, the prediction model module obtains a prediction model of moisture content at the HT outlet, a prediction model of moisture content at the outlet of thin sheet, and a prediction model of the moisture drainage opening OP,dry by fitting a correlation function;
a model control module,
configured to realize automatic data collection, calculation and control by embedding the established prediction models into a control system of the shredded tobacco leaf drying machine to realize automatic data collection, calculation and control;
and, an abnormality early warning module,
configured to give an alarm when a deviation between a predicted value and a measured value of the moisture content at the outlet of the thin sheet is greater than or equal to 0.5%, and enter into an abnormality treating process.
